(19) United States
(12) Patent Application Publication
(10) Pub. No.: US 2014/0143573 A1
(43) Pub. Date: May 22, 2014

(54) COMMUNICATION DEVICE AND METHOD

(71) Applicant: Kabushiki Kaisha Toshiba, Minato-ku (JP)

(72) Inventors: Takeshi ISHIHARA, Yokohama-shi (JP); Yuichiro Oyama, Fuchu-shi (JP); Hiroshi Nishimoto, Kawasaki-shi (JP); Kotaro Ise, Kawasaki-shi (JP)

(73) Assignee: Kabushiki Kaisha Toshiba, Minato-ku (JP)

(21) Appl. No.: 14/074,977

(22) Filed: Nov. 8, 2013

(30) Foreign Application Priority Data
Nov. 20, 2012 (JP) 2012-254763

(51) Int. Cl. G06F 1/32

(52) U.S. Cl. CPC G06F 1/3287
USPC 713/323

(57) ABSTRACT

According to an embodiment, a communication device includes a first processor and a second processor. The first processor is switchable to a sleep state having low power consumption. The second processor performs operations related to information acquisition via a network. The second processor includes a networking unit, an information obtaining unit, and a start-up control unit. Based on first information which indicates a connection destination of the network as specified in the first processor, the networking unit performs communication with the connection destination and notify a permission of switching the first processor to the sleep state. The information obtaining unit obtains second information which is associated to the first information. The start-up control unit switches the first processor back to an operating state from the sleep state when the information obtaining unit finishes obtaining the second information associated to the first information specified by the first processor.

### CROSS-REFERENCE TO RELATED APPLICATION(S)

This application is based upon and claims the benefit of priority from Japanese Patent Application No. 2012-254763, filed on Nov. 20, 2012; the entire contents of which are incorporated herein by reference.

### FIELD

Embodiments described herein relate generally to a communication device and a communication method.

### BACKGROUND

Typically, regarding a communication device that performs communication using a network, a technology is known to equip the communication device not only with a primary processor but also with a separate processor dedicated for communication-related processing. For example, a communication system is known in which, depending on the communication request, operations to be assigned to a network-dedicated processor are identified and are performed in the network-dedicated processor; while the other operations are performed in the primary processor. In such a communication device, it becomes possible to reduce the operational load on the primary processor as well as to speed up the processing.

Moreover, a technology has been disclosed in which the information for which a primary processor issues an acquisition request via a network is obtained prior to the acquisition request. For example, a technology is known in which an information terminal issues a data acquisition request to a webpage; and a proxy server mediates between the information terminal and a web server and obtains in advance the information determined to be requested by the information terminal.

However, in a communication device having a plurality of processors installed therein as described above; the greater the number of processors, the greater is the power consumption. Hence, there is a demand that, when a particular processor is not performing operations, the power consumption of the processor is curbed.

### BRIEF DESCRIPTION OF THE DRAWINGS

FIG. 1 is a block diagram illustrating a communication device according to a first embodiment;

FIG. 2 is a block diagram illustrating the communication device according to the first embodiment;

FIG. 3 is a diagram illustrating a data structure of a correspondence table in the communication device according to the first embodiment;

FIG. 4 is a flowchart for explaining a sequence of operations performed in a first processor according to the first embodiment;

FIG. 5 is a flowchart for explaining a sequence of operations performed in a second processor according to the first embodiment;

FIGS. 6A and 6B are flowcharts for explaining a sequence of operations performed during an information obtaining operation according to the first embodiment;

FIG. 7 is a timing chart illustrating the relationship between the power state transition of the first processer and the power consumption thereof according to the first embodiment;

FIG. 8 is a block diagram illustrating a communication device according to a second embodiment;

FIG. 9 is a flowchart for explaining a sequence of operations performed during an information obtaining operation according to the second embodiment;

FIG. 10 is a timing chart illustrating the relationship between the power state transition of a first processer and the power consumption thereof according to the second embodiment;

FIG. 11 is a timing chart illustrating the relationship between the power state transition of a first processer and the power consumption thereof according to a third embodiment;

FIG. 12 is a timing chart illustrating the relationship between the power state transition of the first processer and the power consumption thereof according to the third embodiment;

FIG. 13 is a block diagram illustrating a communication device according to the third embodiment;

FIG. 14 is a block diagram illustrating a communication device according to a fourth embodiment;

FIG. 15 is a flowchart for explaining a sequence of operations performed to determine the timing for sending a switchback signal according to a fifth embodiment; and

FIG. 16 is a diagram for explaining an additional acquisition list according to the embodiments.

### DETAILED DESCRIPTION

According to an embodiment, a communication device includes a first processor and a second processor. The first processor is switchable to a sleep state having low power consumption. The second processor performs operations related to information acquisition via a network. The second processor includes a networking unit, an information obtaining unit, and a start-up control unit. Based on first information which indicates a connection destination of the network specified by the first processor, the networking unit performs communication with the connection destination and notify a permission of switching the first processor to the sleep state. The information obtaining unit obtains second information which is associated to the first information. The start-up control unit switches the first processor back to an operating state from the sleep state when the information obtaining unit finishes obtaining the second information associated to the first information specified by the first processor.

A first embodiment of a communication device according to the invention is described below in detail with reference to the accompanying drawings. However, the invention is not limited to the first embodiment. Moreover, although the following explanation is given for a case in which the communication with a WEB server 200 is performed using HTTP (which stands for HyperText Transfer Protocol), neither the communication protocol is limited to HTTP nor the other side of communication is limited to the WEB server 200.

### First Embodiment

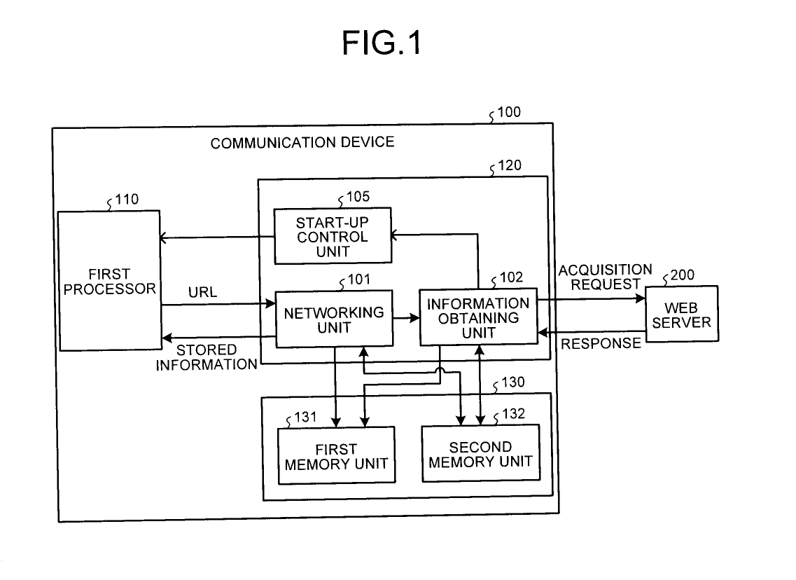

FIG. 1 is a diagram illustrating a hardware configuration as well as functional blocks of a communication device 100 according to the first embodiment. As illustrated in FIG. 1, the communication device 100 includes a first processor 110, a second processor 120, and a memory unit 130 as hardware components. The first processor 110 is the processor for performing mainly the general operations of the communication device 100, and is configured using a central processing unit (CPU). Moreover, the first processor 110 has a plurality of power states. For example, the first processor 110 has an operating state in which the normal electrical power is supplied; and has a sleep state in which some of the power supply is discontinued so as to switch the communication device 100 into the power saving mode. The second processor 120 is the processor for performing operations related to the communication of information via a network. The memory unit 130 is a memory area configured using, for example, a hard disk drive (HDD), a solid state drive (SSD), a NAND-type flash memory, or a random access memory (RAM). The memory unit 130 includes a first memory unit 131 and a second memory unit 132 for storing data in accordance with the nature of the data. The first memory unit 131 is a readable-writable memory area that is used to store information having a certain volume of data, such as information obtained mainly from the WEB server 200. The second memory unit 132 is used to store a small amount of information for a short period of time.

The second processor 120 implements the following functions: a networking unit 101, an information obtaining unit 102, and a start-up control unit 105. Usually, these functions are stored in, for example, the memory unit 130 that is a hardware component. Then, the second processor 120, which is a CPU, reads the functions from the memory unit 130 and executes them in a memory. That results in the implementation of the functions. Alternatively, instead of using hardware components, the abovementioned functions can be implemented also using software. The networking unit 101 handles communication protocols, such as TCP/IP (which stands for Transmission Control Protocol/Internet Protocol), on behalf of the first processor 110. When an information acquisition request is received from the first processor 110; the networking unit 101 transfers that request to the information obtaining unit 102.

In response to an information acquisition request received from the networking unit 101, the information obtaining unit 102 obtains webpages from the WEB server 200 via a network; analyzes the webpages; and obtains further information if necessary. In the first embodiment, uniform resource locators (URLs) represent first information; while embedded (included) object in the webpages, for example images and/or scripts, which are specified by URLs represents second information. Then, the information obtaining unit 102 stores the information, which has been obtained from the WEB server 200, in the first memory unit 131. The start-up control unit 105 controls the power states of the first processor 110.

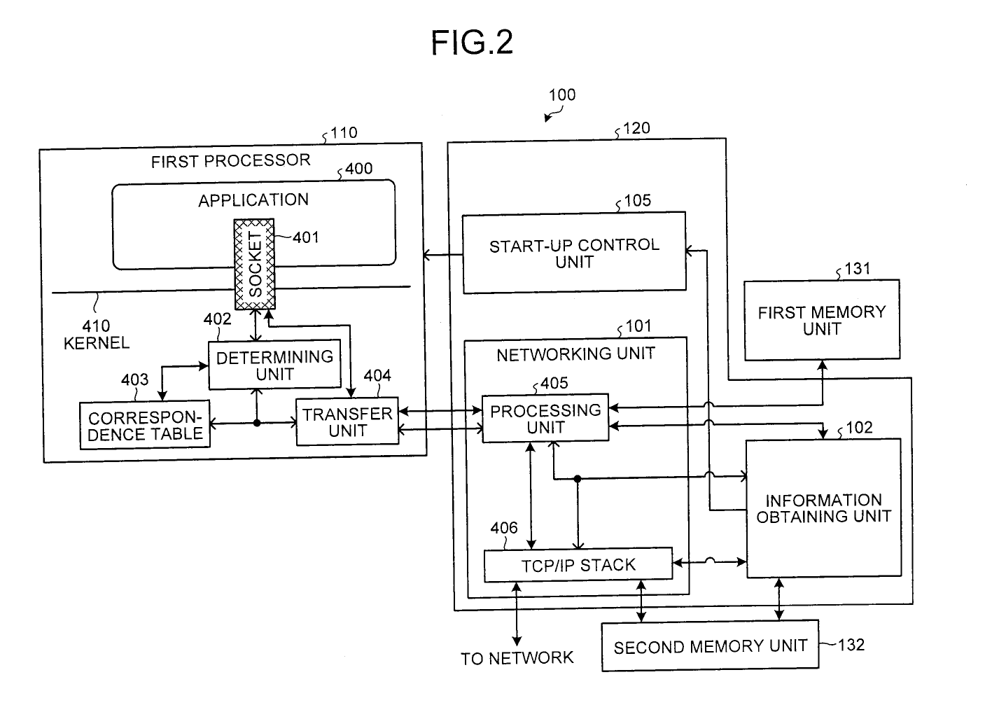

FIG. 2 is a block diagram illustrating in detail the functions of the first processor 110 and the second processor 120. In the first processor 110; an application 400 and a kernel 410 are running. Herein, the kernel 410 includes a determining unit 402, a correspondence table 403, and a transfer unit 404. In an identical manner to commonly-used applications, the application 400 and the constituent elements of the kernel 410 are connected via a socket 401.

The application 400 is software that runs in the first processor 110 and obtains information via a network. For example, the application 400 corresponds to a web browser. The kernel 410 is software that constitutes the operating system (OS) which provides various necessary functions for enabling the operations of the application 400. Generally, the networking is also implemented in the kernel 410. However, in the first embodiment, the networking is implemented in the networking unit 101. The socket 401 communicates data or processing commands between the application 400 and the kernel 410. Generally, the socket 401 connects the application 400 to networking such as TCP/IP. However, in the first embodiment, since the networking is not performed in the kernel 410, the socket 401 connects the application 400 to various functions that enable communication with the networking unit 101.

Regarding particular information, for example, the networking unit 101 notifies the first processor 110 of the acquisition state of the information along with a response to the first information acquisition request issued by the first processor 110. Besides, when the first processor 110 is in the operating state, it can receive such notifications as needed. In any case, the transfer unit 404 that receives a notification stores it in the correspondence table 403 in a corresponding manner to the socket 401. As a result, when a request regarding an embedded object is received, the determining unit 402 can refer to the entries in the correspondence table 403 and can get to know whether or not the target embedded object is already stored in the first memory unit 131. Based on that, the determining unit 402 determines whether to transfer the request to the information obtaining unit 102 or to obtain information from the first memory unit 131.

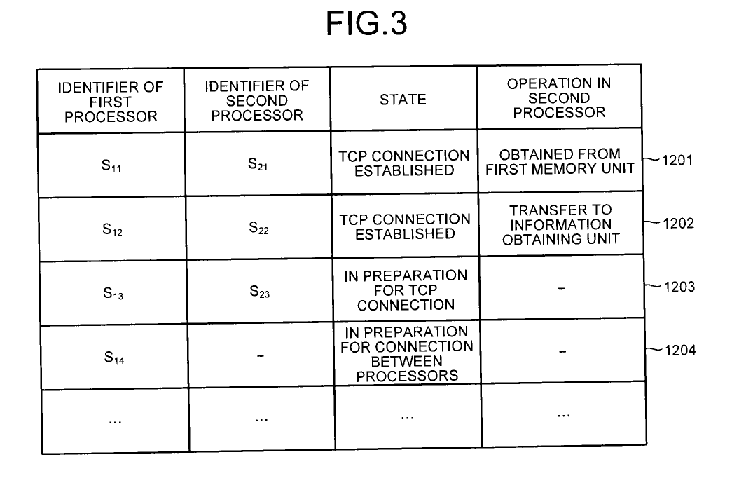

An example of the correspondence table 403 is illustrated in FIG. 3. The correspondence table 403 holds four types of information (namely, the identifier managed/used in the first processor 110, the identifier managed/used in the second processor 120, the state, and the operation in the second processor 120). Given below is the explanation of each entry.

An entry 1201 is related to a connection in which communication with the WEB server 200 has been established. The state is illustrated to be “TCP connection established”, which indicates that communication can already be performed. Moreover, the operation in the second processor 120 is illustrated to be “obtained from the first memory unit 131”, which indicates that the operation in the information obtaining unit 102 is already completed and the response to the original information acquisition request has been sent from the second processor 120 to the first processor 110.

An entry 1202 is another example related to a connection in which communication with the WEB server 200 has been established. In an identical manner to the entry 1201, the state is illustrated to be “TCP connection established”. The operation in the second processor 120 is illustrated to be “transferred to the information obtaining unit 102”. The communication corresponding to the entry 1202 indicates that, immediately after the establishment of communication, it is necessary to perform in-advance batch acquisition according to the first information acquisition request to be issued in future by the first processor 110.

An entry 1203 is an example in which communication with the WEB server 200 is in preparation of being established. The state is illustrated to be “in preparation for TCP connection”, which indicates that a TCP connection is in preparation for being established with the WEB server 200. In this condition, since no operation is performed in the second processor 120, the corresponding column is left blank.

An entry 1204 is an example of the stage at which the necessary connection for communication between the first processor 110 and the second processor 120 is being established. In the entry 1204 is illustrated the following state: an identifier is assigned to the first processor 110; an identifier is transferred from the first processor 110 to the second processor 120; and a request is issued for assigning the identifier to the second processor 120. Hence, the column of the identifier of the second processor 120 is left blank.

The transfer unit 404 performs information transfer with the networking unit 101 based on the determination result of the determining unit 402. During the information transfer, the transfer unit 404 performs appropriate processing of information received via the socket 401. For example, the processing includes assignment of an identifier to the networking unit 101 based on the determination result, changing the format (mode of expression of information), and changing the data size to be communicated at one time. Moreover, the transfer unit 404 performs identical processing with respect to the data received from the networking unit 101, and sends that data to the socket 401 in an appropriate form. Herein, in principle, the information exchanged between the transfer unit 404 and the networking unit 101 contains the portion of data without TCP/IP headers as well as contains headers necessary for networking.

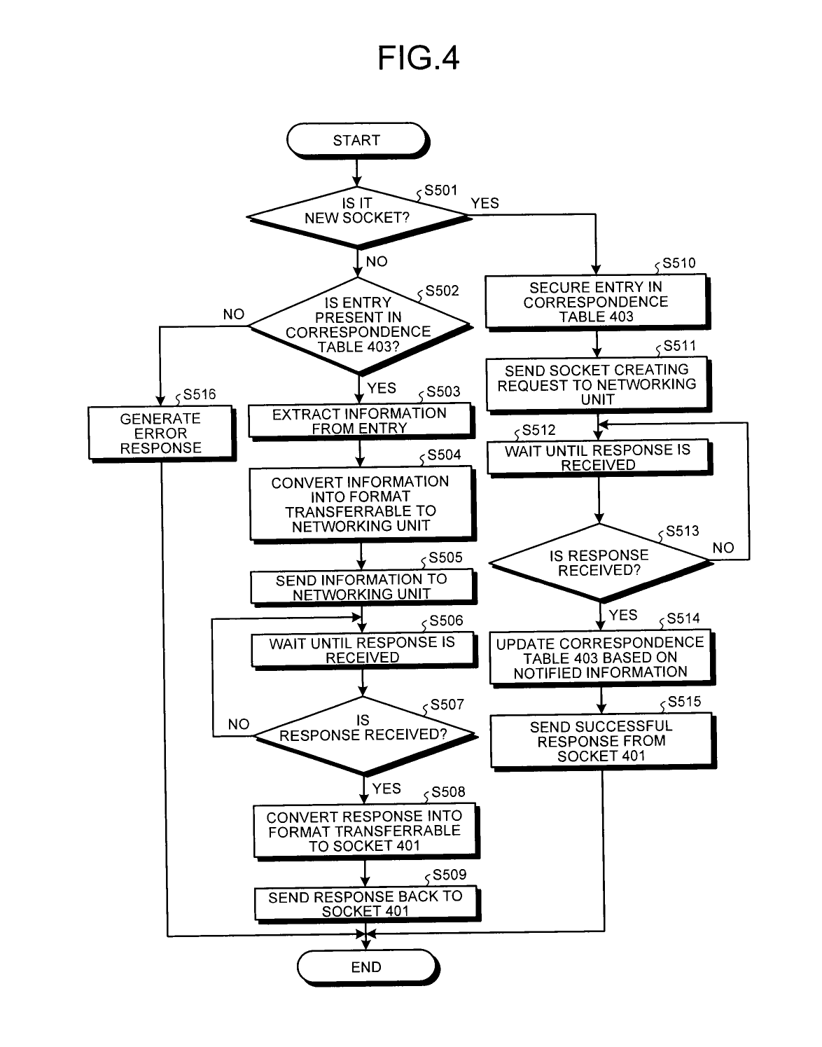

Explained below with reference to FIG. 4 is a detailed sequence of operations performed by each constituent element of the first processor 110. FIG. 4 is a flowchart for explaining a sequence of operations performed during a communication operation of the first processor 110. As illustrated in FIG. 4, firstly, when the socket 401 is generated for communication purpose, it is determined whether the generated socket 401 is a new socket 401 (Step S501). If it is determined that the generated socket 401 is not a new socket 401 (No at Step S501), the determining unit 402 determines, based on the identifier sent from the correspondence table 403 to the socket 401, whether or not a corresponding entry is present (Step S502).

If it is determined that no corresponding entry is present (No at Step S502), then the determining unit 402 generates an error response notification and sends it to the application 400 (Step S516). That marks the end of the operations. On the other hand, if it is determined that the corresponding entry is present (Yes at Step S502), then the transfer unit 404 extracts information from the entry in the correspondence table (Step S503). Subsequently, the transfer unit 404 converts the extracted information into format transferrable to the networking unit 101 (Step S504). The transfer unit 404 sends the converted information to the networking unit 101 (Step S505). After sending the information, the transfer unit 404 waits in a standby state for a response from the networking unit 101 (Step S506). At that time, if sleep permission is received from the networking unit 101, then the transfer unit 404 can switch to the sleep state for a predetermined period of time. The standby state of the transfer unit 404 continues until receiving a response from the networking unit 101 (No at Step S507). Upon receiving a response from the networking unit 101 (Yes at Step S507), the transfer unit 404 converts the response into a format compatible to the socket 401 (Step S508) and sends the response in the converted format to the socket 401 (Step S509). That marks the end of the operations.

Meanwhile, if it is determined that the socket 401 is a new socket 401 (Yes at Step S501), then the determining unit 402 secures an area for adding an entry to the correspondence table 403 (Step S510). Then, the transfer unit 404 issues a socket creating request regarding the socket 401 to the networking unit 101 (Step S511). After issuing the socket creating request, the transfer unit 404 waits in the standby state for a response from the networking unit 101 (Step S512). The standby state of the transfer unit 404 continues until receiving a response from the networking unit 101 (No at Step S513). Upon receiving a response from the networking unit 101 (Yes at Step S513), the transfer unit 404 updates the correspondence table 403 based on the information notified thereto (Step S514). Then, the transfer unit 404 sends back a successful response from the socket 401 to the application 400 (Step S515).

In a general network application, interfaces that are referred to as socket application programming interfaces (APIs) are used to communicate information via a network. The main socket APIs include connect( ) for establishing a communication path to the outside; send( ) for sending information; and recv( ) for receiving information. When the application 400 executes connect( ) the operations from Step S510 to Step S515 are performed. When the application 400 executes send( ) or recv( ) the operations from Step S502 to Step S509 are performed.

When send( ) is executed, the information is sent from the first processor 110 to the networking unit 101 and the information obtaining unit 102, or the information is sent from the first processor 110 to the network directly using a TCP/IP stack 406. The determination of such operations is performed by the determining unit 402. Regarding the determination of operations in the case of executing recv( ), if the execution of send( ) using the same socket 401 is transferred to the information obtaining unit 102, it is determined that the information is to be read from the information obtaining unit 102. At that time, whether or not information is stored in the first memory unit 131 does not pose a problem. If the information is stored, then it is read immediately and the operations are ended. If the information is not stored, storage of information is awaited according to blocking/non-blocking, or a response indicating absence of information is sent and the operations are ended immediately. Other than that, the information is sent to a TCP/IP stack 406 for processing.

Explained below in detail with reference to FIG. 2 is a functional configuration of the second processor 120. The networking unit 101 includes a processing unit 405 and the TCP/IP stack 406. The processing unit 405 sends information to and receives information from the transfer unit 404 that runs in the first processor 110. In an identical manner to the transfer unit 404, the processing unit 405 determines operations based on the information about the identifier assigned to the received request. For example, the processing unit 405 obtains corresponding data from the first memory unit 131, transfers a request to the information obtaining unit 102 and instructs it to collectively obtain the information for which an acquisition request is issued, and transfers a request to the TCP/IP stack 406 to directly communicate with the outside.

The identifier that is used in identifying the communication performed by the TCP/IP stack 406 is stored as an entry in the correspondence table 403 via the processing unit 405 and the transfer unit 404. Meanwhile, in the first embodiment, the explanation is given for an example in which the correspondence table 403 is maintained only in the first processor 110. Alternatively, the correspondence table 403 either can be maintained in the processing unit 405, or can be maintained in the first processor 110 and the processing unit 405 in a shared manner.

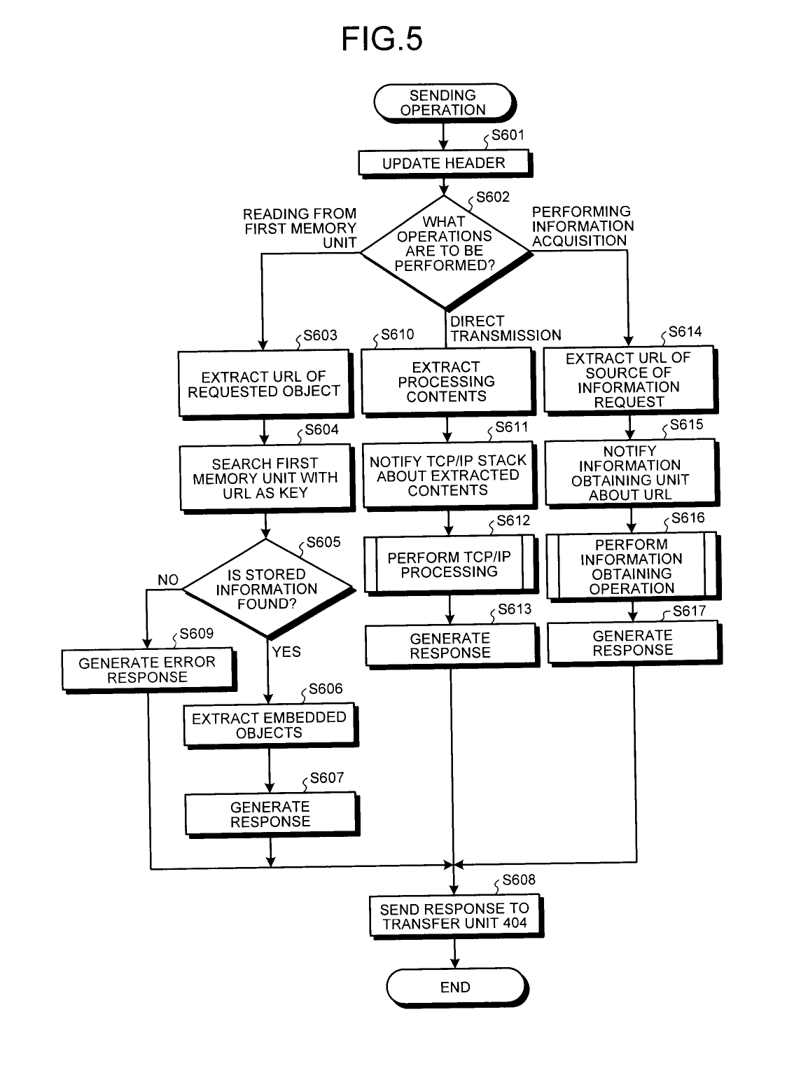

Explained below with reference to FIG. 5 is a sequence of operations performed by each constituent element of the second processor 120. In the second processor 120, the following operations are performed every time an acquisition request is received from the first processor 110. Upon receiving an acquisition request, the processing unit 405 refers to header information specified in the acquisition request and analyzes the header information (Step S601). Then, according to the contents of the header information, the processing unit 405 determines the operations that need to be performed (Step S602).

If the received acquisition request is issued for obtaining corresponding data from the first memory unit 131, then the processing unit 405 extracts the target URL from the acquisition request (Step S603). Subsequently, the processing unit 405 searches the first memory unit 131 with the extracted URL as the key (Step S604); and determines whether or not matching stored information is found (Step S605). If the matching stored information is found (Yes at Step S605), then the processing unit 405 extracts the related embedded objects from the stored information (Step S606). An embedded object is an image file that is embedded in the HTML file identified by a particular URL. Subsequently, the processing unit 405 generates a response to the acquisition request (Step S607).

On the other hand, if the matching stored information is not found (No at Step S605), then the processing unit 405 generates an error response (Step S609) and sends the generated response to the transfer unit 404 (Step S608). That marks the end of the operations. Each error response is independent of the operations performed in the transport layer and the network layer. That is, when networking is performed in the second processor 120, the response points to header information that is necessary to get to know the actual data, the data volume of the data obtained in the second processor 120, and a list of data that needs to be obtained individually.

Meanwhile, regarding the header information (such as an HTTP header) of the application layer which is required at that time, either the processing unit 405 can appropriately generate such header information or the header information obtained from the WEB server 200 by the information obtaining unit 102 can be used without modification. At that time, some portion of the header information can be used in a modified form.

Returning to the determination performed at Step S602, if the request received by the processing unit 405 is issued for performing direct communication using the TCP/IP stack 406; then the processing unit 405 extracts, from the received request, the data portion that is to be notified to the TCP/IP stack 406 (Step S610). Then, the processing unit 405 notifies the TCP/IP stack 406 of the extracted data portion (Step S611). Subsequently, the TCP/IP stack 406 performs processing using the corresponding socket (Step S612). After the processing is completed, the processing unit 405 receives the processing result from the TCP/IP stack 406; converts the processing result into an appropriate format; and finally generates a response by appending the header information, which is required for the exchange of information between the processing unit 405 and the transfer unit 404, to the processing result (Step S613).

Returning to the determination performed at Step S602, if the request received by the processing unit 405 is issued for performing operations in the information obtaining unit 102, the processing unit 405 extracts the URL that needs to be obtained from the received request (Step S614). Then, the processing unit 405 notifies the information obtaining unit 102 of the extracted URL (Step S615). Subsequently, the information obtaining unit 102 performs a prefetch operation (described below) (Step S616).

During the prefetch operation, the requested information is obtained along with collecting the embedded objects, and such information is stored in the first memory unit 131. At the time of storing the embedded objects, for example, each embedded object is stored along with the URL serving as the key. In addition, it is also possible to think of a method in which the hash value based on the URL is used as the key. Lastly, when all collectable embedded objects are collected, the processing unit 405 is notified of the completion of the prefetch operation.

The processing unit 405 generates a response to the acquisition request (Step S617) and sends the response to the application 400 via the transfer unit 404 (Step S608). Herein, the response generated by the processing unit 405 includes an HTTP header and data. Regarding the HTTP header, either the processing unit 405 can generate the HTTP header or the HTTP header notified from the WEB server 200 can be used without modification.

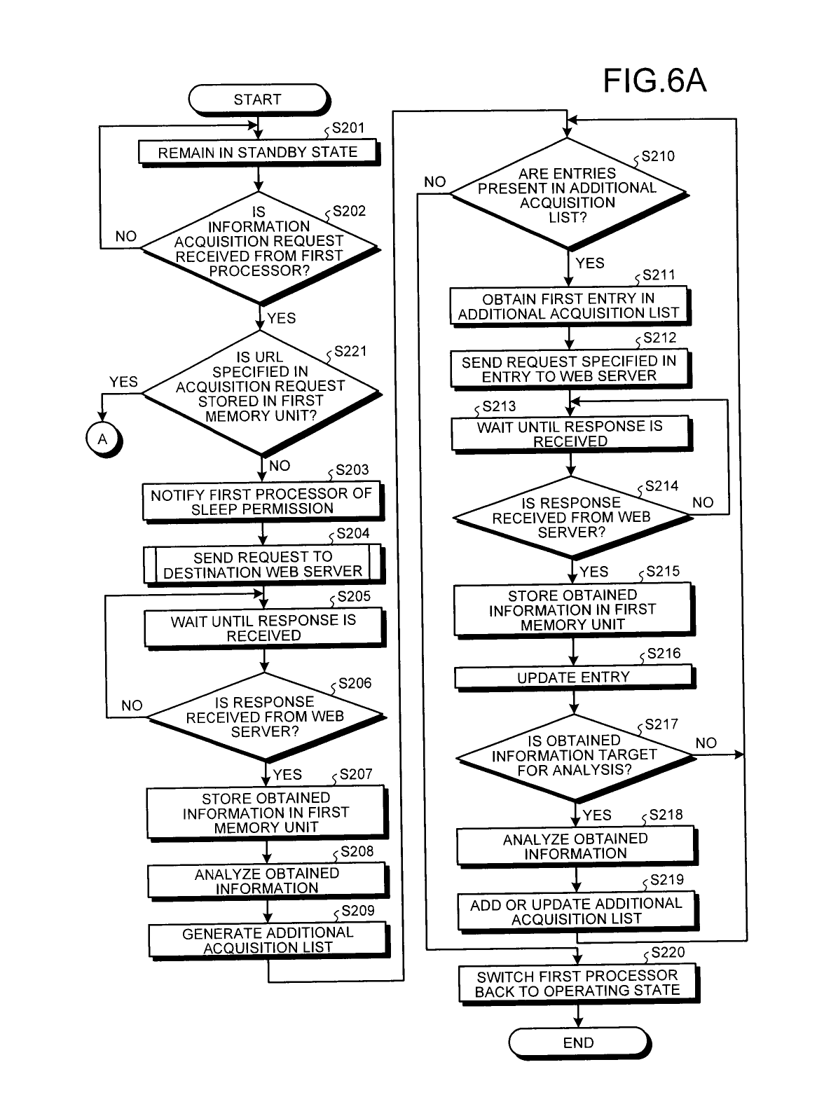

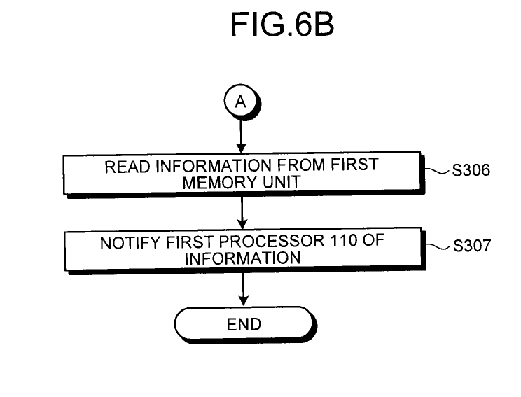

FIGS. 6A and 6B are flowcharts related to the prefetch operation according to the first embodiment, and illustrate a sequence of operations performed in the second processor 120. These flowcharts are only exemplary, and the operations can be performed in a different sequence as long as the same effect is achieved.

As illustrated in FIG. 6A, when the first processor 110 notifies the networking unit 101 of an acquisition request for obtaining the URL of an HTML file stored in the WEB server 200, the operation of obtaining a webpage starts in the communication device 100. Till then, the second processor 120 remains in the standby state (Step S201). During that period, the second processor 120 can switch to the sleep state, which is a low power consumption state, for reducing the power consumption. Meanwhile, if the first processor 110 attempts to obtain a plurality of URLs, then the following operations are repeated until all the URLs are obtained.

When the first processor 110 notifies the networking unit 101 of the acquisition request (Yes at Step S202); the networking unit 101 determines whether or not the information identified by the URL, which is specified in the acquisition request, is stored in the first memory unit 131 (Step S221). If the URL is not stored in the first memory unit 131 (No at Step S221), then the networking unit 101 notifies the first processor 110 of the permission to switch to the sleep state (Step S203).

During the following operations, the first processor 110 remains switched to the sleep state. Unless there is no other reason to keep on performing the operations; the first processor 110, which has received the permission to switch to the sleep state, switches to the sleep state.

Upon receiving an information acquisition request, the networking unit 101 gets to know that the request points to a webpage acquisition request and notifies the information obtaining unit 102 of the request. Then, the information obtaining unit 102 analyzes the received request and sends it to the WEB server 200 that is identified by the URL (Step S204). Subsequently, the information obtaining unit 102 waits in the standby state for a response from the WEB server 200 (Step S205). When a response is received from the WEB server 200 (Yes at Step S206), the information obtaining unit 102 stores the obtained information in the first memory unit 131 (Step S207). Herein, the obtained information points to, for example, HTML data. However, the data of embedded objects, such as image files or style sheets, is not yet obtained at that point of time.

Then, the information obtaining unit 102 analyzes the information stored in the first memory unit 131 and extracts information that enables identification of the embedded objects (Step S208). Herein, an embedded object points to an image file (identified by an <IMG> tag) or a script file (identified by a <SCRIPT> tag) that is referred to from an HTML file.

Subsequently, the information extracted by the information obtaining unit 102 is stored as a new acquisition request in an “additional acquisition list” in the second memory unit 132 (Step S209).

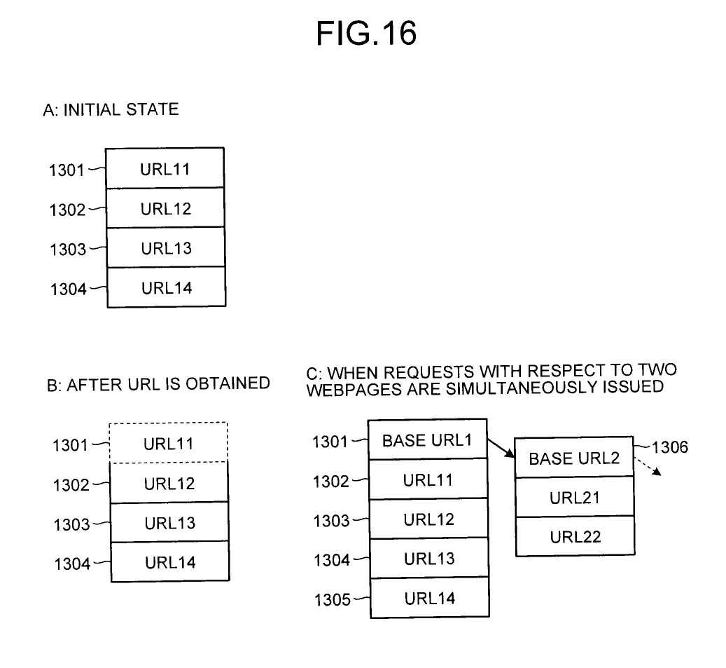

An example of the additional acquisition list is illustrated in FIG. 16. In this example, it is illustrated that two lists are joined as the additional acquisition list. Alternatively, it is also possible to configure the additional acquisition list as a single list. As long as the list contains target information for in-advance batch acquisition, it serves the purpose.

When an information acquisition request with respect to a particular webpage is issued and when the information obtaining unit 102 has completed the analysis, a list illustrated in “A: initial state” is generated in the second memory unit 132. The information obtaining unit 102 makes use of the list to access each URL and obtains the information. For example, when an URL11 1301 can be obtained, the acquisition list falls in the state “B: after URL11 is obtained”. In FIG. 16, the URL11 1301 is enclosed with dashed lines. However, in practice, in order to distinguish the URL11 1301 from un-obtained URLs, it is either removed from the list or the entry thereof is marked with an already-obtained sign.

Meanwhile, if acquisition requests with respect to a plurality of webpages are issued at the same time, the URLs can be managed by joining a plurality of lists as illustrated in “C: when requests with respect to two webpages are simultaneously issued”.

Subsequently, the information obtaining unit 102 determines whether or not the additional acquisition list is stored in the second memory unit 132 (Step S210). If it is determined that there is no entry in the additional acquisition list stored in the second memory unit 132 (No at Step S210), and if the first processor 110 is in the sleep state; then the start-up control unit 105 switches the first processor 110 to the operating state (Step S220). That marks the end of the operations. At that time, as the method of switching the first processor 110 to the operating state, it is possible to think of enabling an interrupt signal, or resuming the supply of clock signals, or turning ON the power. In this case, for example, if the acquisition request notified from the first processor 110 is not issued with respect to an HTML file, that is, if the acquisition request is issued with respect to an image file; no URL is extracted at Step S208. Hence, no entry is generated in the additional acquisition list.

If it determined that the additional acquisition list has an entry (Yes at Step S210), then the information obtaining unit 102 performs operations to obtain an embedded object according to the additional acquisition list. The information obtaining unit 102 issues a request to the WEB server 200 that is identified by the URL of the embedded object (Step S212). Then, the information obtaining unit 102 waits in a standby state for a response from the WEB server 200 (Step S213). When a response is received from the WEB server 200 (Yes at Step S214), the information obtaining unit 102 stores the obtained information in the first memory unit 131 (Step S215). Then, the information obtaining unit 102 updates the additional acquisition list by deleting the entry corresponding to the obtained information (Step S216).

Subsequently, the information obtaining unit 102 determines whether or not the obtained embedded object is the target for analysis, that is, whether or not the obtained embedded object is an HTML file (Step S217). If it is determined that the obtained embedded object is the target for analysis (Yes at Step S217), then the information obtaining unit 102 analyzes the obtained information (Step S218). Then, the information obtaining unit 102 updates the additional acquisition list using the URL of the embedded object obtained as a result of the analysis (Step S219). The system control then returns to Step S210, and the operations are repeated until all entries in the additional acquisition list are processed. Meanwhile, whether or not an obtained embedded object is the target for analysis is determined based on whether the obtained information is in the text format or whether the obtained embedded object matches with the content type set in advance (i.e., whether the value specified in the Content-Type header of HTTP matches with the value set in advance). Herein, advance setting means that, for example, static information such as a style sheet or a script file is considered to be the target for analysis; but a JPEG image is not considered to be the target for analysis. Besides, any URL obtained as a result of executing a script is not considered to be the target for analysis. Meanwhile, if it is determined that the obtained information is not the target for analysis (No at Step S217), then the system control returns to Step S210 and the operations are repeated.

Returning to Step S221, if the URL is stored in the first memory unit 131 (Yes at Step S221), then the system control proceeds to Step S306 illustrated in FIG. 6B. In this case, the first processor 110 does not switch to the sleep state, and the subsequent operations are performed with the first processor 110 remaining in the normal state. That is, during the operations from Step S306 onward, the first processor 110 remains in the operating state. The information obtaining unit 102 reads the information from the first memory unit 131 (Step S306); and generates a response and notifies the first processor 110 of the response (Step S307). Herein, the information that is obtained in advance by the second processor 120 and that is stored in the first memory unit 131 either can be deleted after the notification to the first processor 110 or can be held as it is. In the case of holding the information, it can be managed according to the validity period management method specified in the communication protocol (for example, according to the cache validity period defined in HTTP1.1), or can be managed according to an original method.

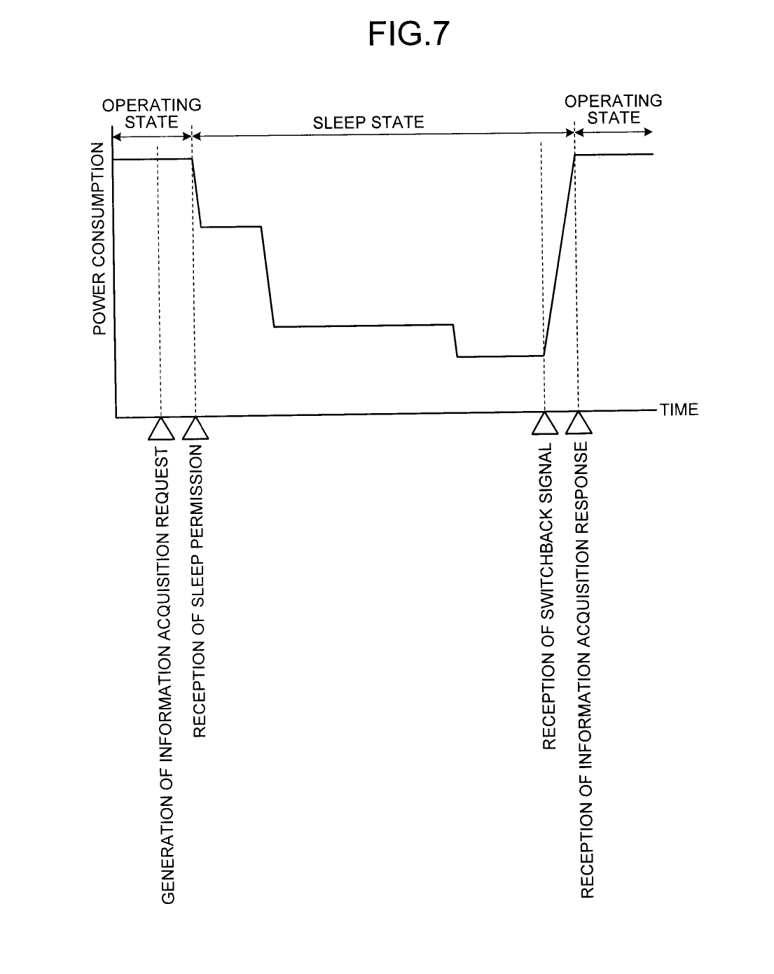

Explained below with reference to FIG. 7 is the transition of states of the first processor 110. As illustrated in FIG. 7, the first processor 110 sends an information acquisition request to the second processor 120 and receives the sleep permission from the second processor 120. Thus, during the period starting from generating the first information acquisition request up to receiving a sleep state permission notification (i.e. up to Step S203), the first processor 110 is in the operating state. Then, upon receiving a sleep permission notification from the networking unit 101, the first processor 110 switches to the sleep state. Then, until a switchback signal for switching back to the operating state is received from the networking unit 101 (i.e., until Step S220), the first processor 110 remains in the sleep state. Once the switchback signal is received, the first processor 110 switches back to the operating state and obtains the information that has been obtained by the second processor 120 from the WEB server 200 and that has been stored in the first memory unit 131. Meanwhile, in the first embodiment, the first processor 110 has a plurality of sleep state types. That is, as the period of time to be continually in the sleep state goes on increasing, the first processor 110 goes on switching to the sleep state types having lesser power consumption.

In this way, in the communication device 100 according to the first embodiment, the first processor 110 issues an information acquisition request. In response, the second processor 120 collectively obtains pieces of second information that are associated to the information for which the information acquisition request is issued. At that time, the first processor 110 is switched to the sleep state so that the power consumption thereof can be reduced. Moreover, at the point of time when all pieces of second information are obtained by the second processor 120, the first processor 110 is switched back to the operating state so that it can swiftly resume the operations.

### Second Embodiment

Given below is the explanation of a second embodiment in which the communication device according to the invention is put into effect. The second embodiment differs in the way that, at the time of switching a first processor to the sleep state, the sleep time is set based on the information for which an information acquisition request is issued to a second processor and based on the time required to obtain the information of each object that is linked to the information for which an information acquisition request is issued. The detailed explanation is given below.

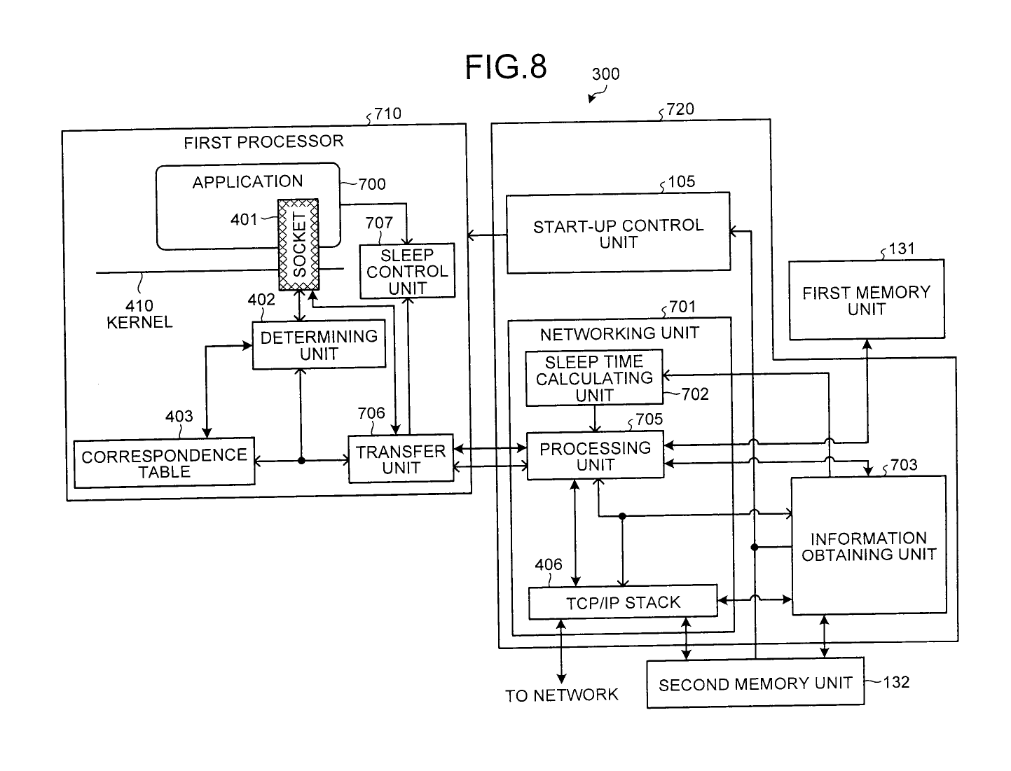

FIG. 8 is a functional block diagram of a communication device 300 according to the second embodiment. Herein, the constituent elements identical to the constituent elements of the communication device 100 illustrated in FIG. 2 according to the first embodiment are referred to by the same reference numeral, and the explanation thereof is not repeated.

As illustrated in FIG. 8, in a second processor 720, a networking unit 701 includes a processing unit 705 and a sleep time calculating unit 702. Herein, at the time when an information obtaining unit 703 obtains in advance the information in a collective manner, the sleep time calculating unit 702 calculates an estimate of the sleep time for which a first processor 710 can remain in the sleep state. The information necessary for calculating the sleep time is obtained from the information obtaining unit 703 and the second memory unit 132.

The processing unit 705 notifies the first processor 710 of the sleep time that is calculated by the sleep time calculating unit 702. A transfer unit 706 extracts the notified sleep time from the networking unit 701, and notifies a sleep control unit 707 of the sleep time. Meanwhile, an application 700 can also be notified about the information related to the sleep time, and can be instructed to prompt state transition. The sleep control unit 707 switches the first processor 710 to the sleep state while ensuring that the sleep time notified by the processing unit 705 or by the application 700 is not crossed.

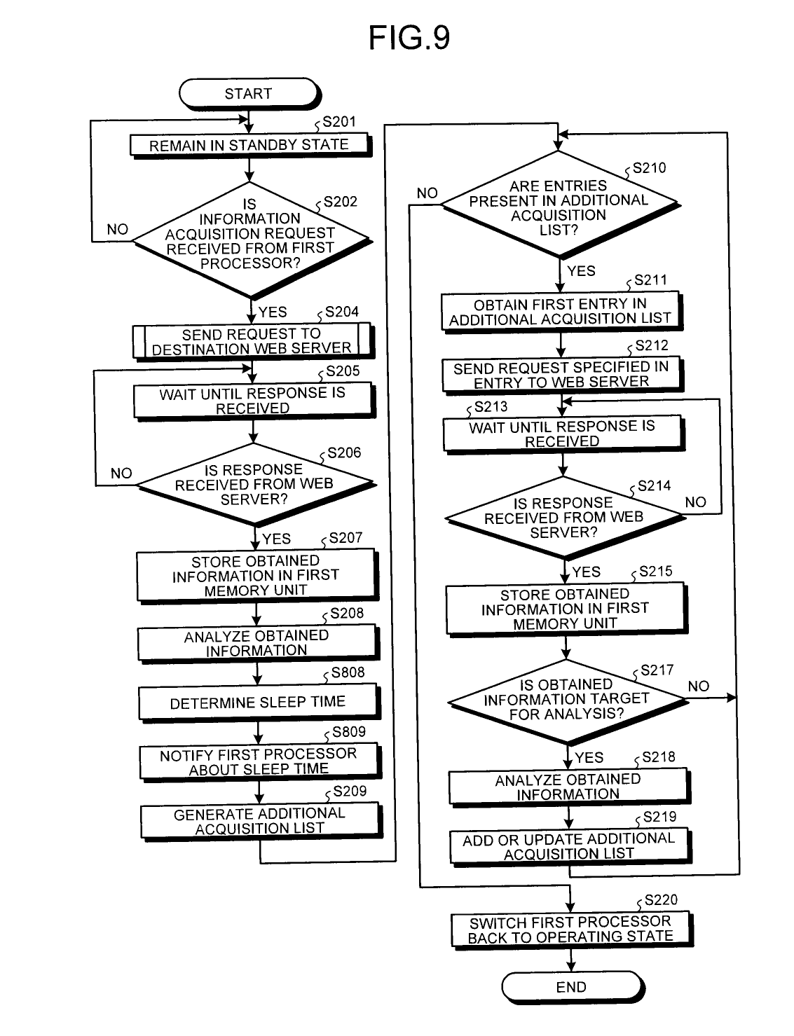

FIG. 9 is a flowchart for explaining a sequence of operations performed in the second processor 720 for obtaining information. As compared to the flowchart illustrated in FIG. 6A, the flowchart illustrated in FIG. 9 has Step S808 and Step S809 newly added therein. Since the other steps are identical to the flowchart illustrated in FIG. 6A, the explanation thereof is not repeated. The sleep time calculating unit 702 calculates the sleep time based on the information stored in the first memory unit 131 (Step S808).

The sleep time can be calculated by implementing any of the following three methods. The first method is to make use of the amount of required time for the communication performed in the past with the WEB server 200. Regarding the URL specified by the information obtaining unit 703 at the time of obtaining information, the amount of required time for obtaining the embedded object related to that URL is stored in the first memory unit 131 in a corresponding manner to the URL. When the stored URL is accessed; the sleep time calculating unit 702 obtains the amount of required time stored in a corresponding manner to the URL as the sleep time, and notifies the first processor 710 of the sleep time via the processing unit 705.

However, in this method, if the URL is accessed for the first time, it is not possible to calculate the sleep time. Hence, regarding the first-time access, either a predetermined fixed value can be used or the value corresponding to a similar URL, for example, a URL having the same domain name can be used. Alternatively, regarding the first-time access, the sleep time may not be notified and the switchback to the operating state can be done in response to the notification from the second processor 720 about obtaining the information.

Although the above explanation is given for the method in which the amount of required time is stored for each URL, it is also possible to divide the URLs in groups and store the amount of required time for each group, or to store only the average time of the amount of required time for all URLs. The URLs can be divided into groups based on the same servers, the same domains, or related domains; or can be divided into groups based on the time and place of obtaining the information; or can be divided into groups based on the communication method or the network interface used in obtaining the information. Moreover, regarding the amount of required time for a plurality of URLs; it is possible to consider the average amount of time, the smallest amount of time, or the largest amount of time.

The second method for calculating the sleep time is to make use of the number of embedded objects included in the obtained HTML and the characteristic information of the network (for example, RTT (RoundTripTime) or throughput). In the case when the number of embedded objects is N and RTT is r seconds, then it can be estimated that obtaining the information requires N×r seconds or more. In the case when a plurality of objects can be obtained at the same time, it is possible to think that obtaining the information requires N/p×r, where p represents the number of objects that can be obtained at the same time. Meanwhile, the network characteristic information is calculated by the information obtaining unit 703 from the time required for HTML acquisition. Alternatively, it is also possible to think of a method in which an inquiry about the network characteristic information is made to a separately-installed network management server.

The third method for calculating the sleep time is to calculate the transfer time of embedded objects by taking into account the average size of embedded objects and the throughput of embedded objects, and add the transfer time to the sleep time. If the average size of embedded objects is S (bits) and the throughput of embedded objects is T (bps), then the transfer time per embedded object becomes r+S/T. In the case when all embedded objects are obtained one by one, then the sleep time becomes N×(r+S/T). In the case of obtaining p number of embedded objects at one time, the throughout per embedded object becomes 1/p. Hence, the sleep time becomes N/p×(r+pS/T).

Regarding the average size of embedded objects that is required in such calculations; it is possible to think of a method of using a predetermined fixed value, or a method of using the actual measured value (which is updated every time an embedded object is obtained), or a method of using a value notified from a third party such as a management server. At the time of setting such values, it is also possible to divide the embedded objects into groups for management purpose in an identical manner to the first method. Moreover, instead of making use of the average size, it is also possible to make use of the smallest size among the embedded objects or the largest size among the embedded objects.

Furthermore, it is also possible to use a value obtained by adding/subtracting a fixed value α with respect to any of the three methods described above. Since each of the methods described above represents a value based on either the empirical values or estimation, there is a possibility that the actual time taken for the completion of collective acquisition is different than the calculated time. Such a difference may lead to unnecessary power consumption or may lead to delays in responses. In order to regulate such issues, it is possible to adjust the value using some sort of a fixed value α.

Thus, the sleep time calculating unit 702 calculates the sleep time in the abovementioned manner. Then, the processing unit 705 notifies the first processor 710 of the calculated sleep time (Step S809). Herein, the sleep time is sent along with the notification of the permission for the first processor 710 to switch to the sleep state. Upon receiving the notification, the sleep control unit 707 of the first processor 710 takes into account the state of the application 700 and the kernel 410 that are run by the first processor 710; selects the most suitable sleep time from among the various periods of time that are notified; and switches the first processor 710 to the corresponding sleep state.

Given below is the explanation of the methods of notifying the sleep time. The sleep time can be notified by implementing any of two methods. In the first method, the sleep time is conveyed as a response to a reception command issued by the application 700. For example, assume that the application 700 executes a recv( ) system call and is waiting for the first HTML file. In that case, the sleep time calculating unit 702 calculates the sleep time and notifies the sleep time controller 707 of the sleep time as a response to recv( ). In order to distinguish the notification from a normal HTTP response, it is sent along with an appropriate HTTP response code header. For example, a response code 103 is assumed to be used as “sleep response” and a response header “X-sleep-Time: 10” is added as the response header for notifying the sleep time.

Upon receiving an HTTP response having such information accompanying it, the application 700 detects that the sleep time is specified in the response and notifies the sleep control unit 707 of the sleep time. Meanwhile, in parallel to the calculation of the sleep time, if downloading of an HTML file is also completed; then it is also possible to add a response header, which notifies the sleep time, to the normal response containing the downloaded HTML file.

In the second method of notifying the sleep time, in the header appended to the information exchanged between the transfer unit 706 and the processing unit 705, a code number representing special information for notifying the sleep time is appended. The transfer unit 706 detects the message containing the special code number; extracts the sleep time from the message; and notifies the sleep control unit 707 of the sleep time.

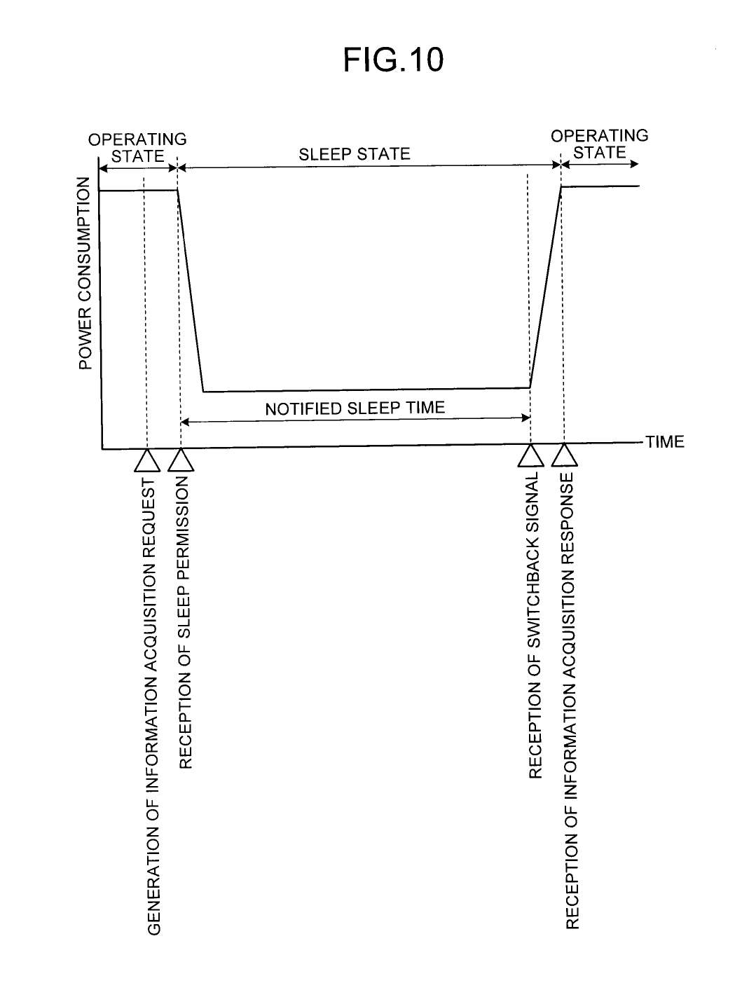

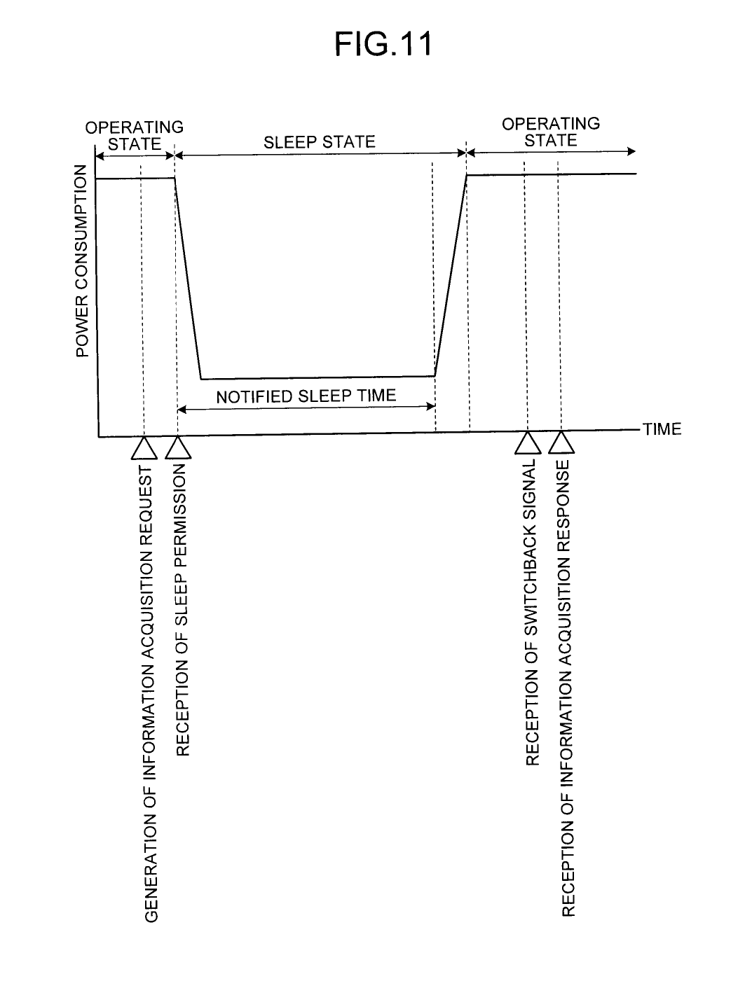

Explained below with reference to FIG. 10 is the transition of power consumption of the first processor 710 in the communication device 300 according to the second embodiment. As explained in FIG. 10, the first processor 710 receives the sleep permission to switch to the sleep state from the second processor 720 and switches to the sleep state. At that time, based on the sleep time notified along with the sleep permission, the sleep control unit 707 switches the first processor 710 into a deep sleep state from the beginning. However, if the sleep time is too short, then the first processor switches back to the operating state earlier than the actual switchback signal as illustrated in FIG. 11. That may lead to unnecessary power consumption.

Thus, in the communication device 300 according to the second embodiment, the first processor 710 switches to the sleep state according to the sleep time set based on the obtained information. Hence, the transition to a suitable switch state can be done in a swift manner. After the sleep time is elapsed, the first processor 710 switches back to the operating state. Hence, at the timing at which a response regarding information acquisition is sent from the second processor 720, the first processor 710 is in the operating state. As a result, it becomes possible to reduce the possibility of a decline in the processing speed due to the switchback operation.

### Third Embodiment

Given below is the explanation of a third embodiment. In the third embodiment, the sleep control unit 707 controls the state of the first processor 710 in such a way that the first processor 710 switches to a deep sleep state for a period of time shorter by a certain amount of time δ than the sleep time notified from the second processor 720. Moreover, the sleep control unit 707 controls the state of the first processor 710 in such a way that the first processor 710 switches to a shallow sleep state in the intervening period between the elapse of the time shorter by a certain amount of time δ than the notified sleep time and the time at which a switchback instruction is issued. In the shallow sleep state, the time required to switch back to the operating state is shorter as compared to the deep sleep state.

In the second embodiment as described above, a switchback instruction is issued after all objects are received. Hence, if a response is notified before the elapse of the sleep time, then the first processor 710 may take time to resume operations. In that regard, in the third embodiment, before all the information is obtained, the first processor 710 is switched to the shallow sleep state.

There are two methods for calculating the time reduction δ. Given below is the detailed explanation of those methods. Firstly, the explanation is given about a method of calculating the time reduction δ only in the first processor 710. First of all, the sleep control unit 707 obtains the sleep time that is notified before the first processor 710 switches to the sleep state. Regarding the time point at which the first processor 710 switches back to the operating state according to a notification from the start-up control unit 105, the sleep control unit 707 can get to know the time point from the built-in clock of the first processor 710.

Then, at the time point at which the first processor 710 switches back to the operating state, the sleep control unit 707 calculates a difference ΔT in the switchback timing by referring to the two pieces of information. The difference ΔT is calculated every time a piece of information is obtained, and is updated to a new difference ΔT′ based on past values. For example, the difference ΔT is the average value, the smallest value, or the largest value of the differences calculated in past. Then, a function f that performs fixed weighting with respect to the last difference ΔT′ is used, and δ=f(ΔT′) is obtained. Herein, the function f represents, for example, multiplication of an arbitrary value greater than zero.

Meanwhile, it is also possible to calculate the reduction δ in the processing unit 705. In this case, there are more than one methods for obtaining the reduction δ. The simplest method is to use a fixed value that is set in advance. Another method is to obtain ((average RTT)−(smallest RTT)) using the RTT information measured by the information obtaining unit 703, and consider ((average RTT)−(smallest RTT)) as the reduction δ. Still another method is to obtain ((average acquisition time)−(smallest acquisition time)) using the time required at previous instances of obtaining the information, and consider ((average acquisition time)−(smallest acquisition time)) as the reduction δ. Moreover, functions f1(N, δ) or f2(S, δ), which perform weighting by taking into account the number N of embedded objects or the size S of embedded objects, can be used with respect to the reduction δ obtained in the abovementioned manner. As an example of weighting, it is possible to think of multiplying the reduction δ by a small number from 0 to 1; or by N; or by S.

Meanwhile, it is also possible to have a case in which the networking unit 701 calculates the sleep time and the reduction δ separately, and notifies the same. Alternatively, the networking unit 701 can shorten the calculated sleep time by a period of time equivalent to the reduction δ, and notify the shortened sleep time.

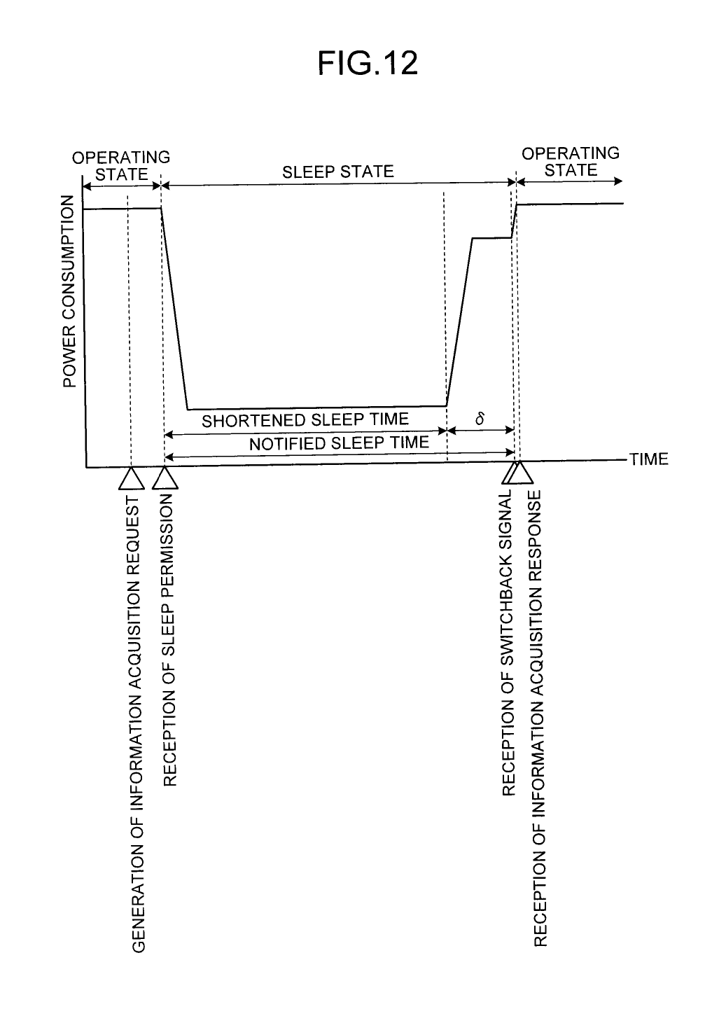

Explained below with reference to FIG. 12 is the relationship between the state of the first processer 710 and the power consumption thereof according to the third embodiment. As illustrated in FIG. 12, the first processor 710 switches to the deep sleep state for the shortened sleep time that is obtained by shortening the notified sleep time by the reduction δ. Then, after the elapse of the shortened sleep time; the first processor 710 switches to the shallow sleep time until the elapse of the originally-notified sleep time. When either the shallow sleep state is over or a switchback signal is received from the second processor 720, the first processor switches back to the operating state.

Thus, in the third embodiment, the first processor 710 is switched to the shallow sleep state after a shorter period of time than the notified sleep time. Hence, even in the case when a switchback signal from the second processor 720 is received before the elapse of the sleep time, the first processor 710 can promptly switch back to the operating state. As a result, it becomes possible not only to reduce the power consumption but also to enable achieving efficiency in the operations.

### Fourth Embodiment

Given below is the explanation of a fourth embodiment. In the fourth embodiment, the method of calculating the reduction δ is modified as compared to the third embodiment. The following explanation is given for a case in which the reduction δ is calculated in only a first processor 910. However, it is also possible to implement the other methods described in the third embodiment.

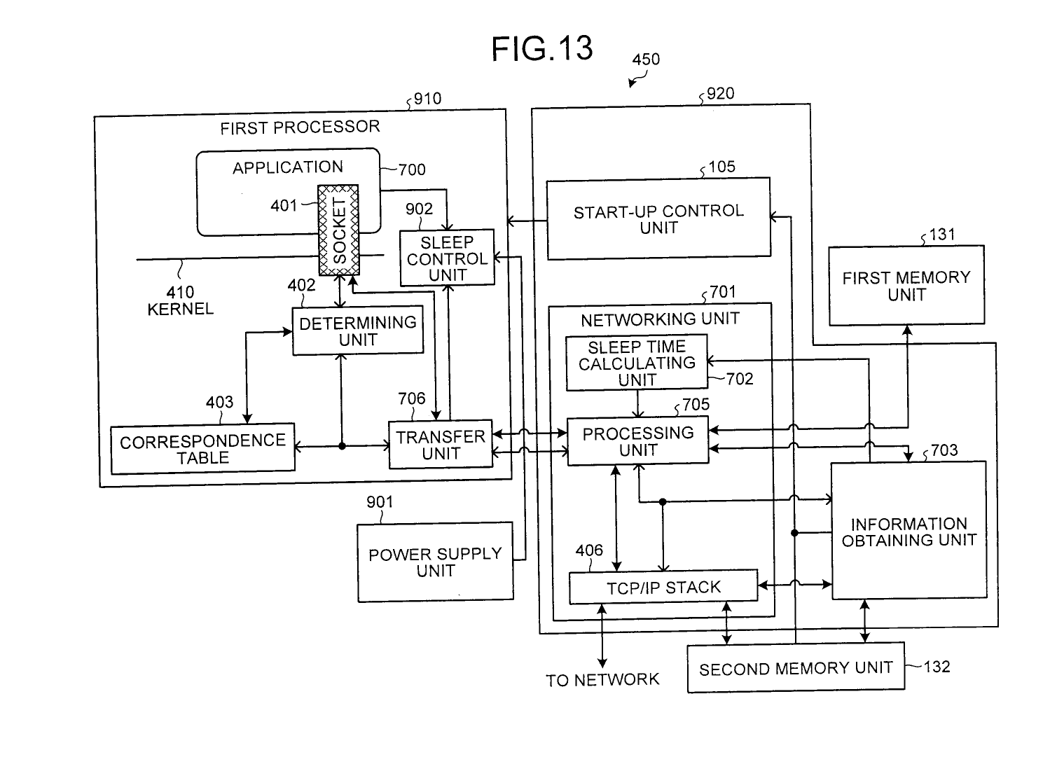

FIG. 13 is a functional block diagram of a communication device 450 according to the fourth embodiment. In addition to the configuration according to the third embodiment, the communication device 450 newly includes a power supply unit 901. Herein, the power supply unit 901 is configured with electrical accumulators such as batteries or capacitors, or is configured with power generating components such as photovoltaic cells; and supplies power to the communication device 450. Moreover, the power supply unit 901 notifies a sleep control unit 902 of the information regarding the power storage amount (the remaining battery level) or the power generation amount.

At the time of calculating the reduction δ, the sleep control unit 902 obtains the current power generation amount, and calculates a reduction δ′=g(ΔT, P) where P represents the normalized value of the power generation amount and ΔT represents the difference in the switchback timing. Herein, the function g( ) performs weighting in such a way that, greater the value of P, the greater becomes the reduction δ′; and smaller the value of P, the smaller becomes the reduction δ′. By calculating the reduction δ′ in this way, when the power generation amount is large, the first processor 910 is switched back to the shallow sleep state at an earlier timing while putting more importance on responsiveness; and when the power generation amount is small, the period for which the first processor 910 is in the shallow sleep state is shortened by putting more importance on power saving.

In the third embodiment, the explanation is given for a method of calculating the reduction δ in a second processor 920 and for a method in which the switchback operation is performed in two steps without using the reduction δ. Even in the case of using those methods, at the timing of actually switching the first processor 910 to the sleep state, correction performed using the value P enables achieving the abovementioned effect. For example, in the case of using the reduction δ that has been notified, adjustment can be done using a function g1( ) such as δ′=g1(δ, P). When the value of P is smaller than a threshold value, the function g1( ) can return such δ′ that δ′<δ is satisfied. On the other hand, when the value of P is greater than the threshold value, the function g1( ) can return such δ′ that δ′>δ is satisfied.

Thus, in the communication device 450 according to the fourth embodiment, the timing of switching back the first processor 910 to the operating state is modified based on the remaining battery level or the power generation amount. Hence, even if power shortage is likely to occur, it becomes possible to achieve power saving as well as responsiveness.

### Fifth Embodiment

Given below is the explanation of a communication device 500 according to a fifth embodiment. In the first to four embodiments, the timing of notifying a switchback signal is set to match the completion of collective acquisition of information by the information obtaining unit. With that, at the timing at which the first processor switches back to the operating state, the operation of obtaining the requested information is certainly over. However, there occurs a time lag until the operations resume. In that regard, in the fifth embodiment, a function is implemented for controlling the timing of notifying a switchback signal according to the information acquisition status of the information obtaining unit.

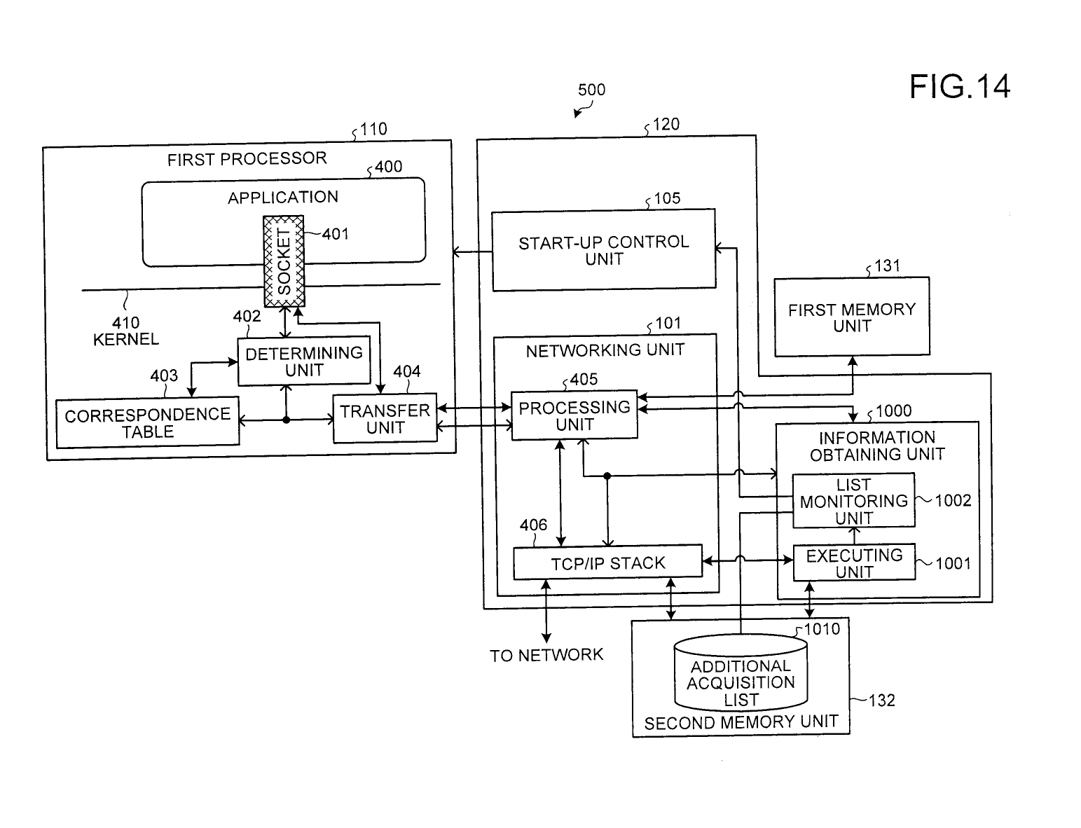

FIG. 14 is a functional block diagram of the communication device 500 according to the fifth embodiment. As illustrated in FIG. 14, an information obtaining unit 1000 includes an executing unit 1001 and a list monitoring unit 1002. Moreover, the second memory unit 132 stores therein an additional acquisition list 1010.

The executing unit 1001 refers to the URLs notified from the networking unit 101 and the URLs stored in the additional acquisition list 1010, and executes an in-advance batch acquisition operation. The information that is obtained is store in the first memory unit 131. Every time an embedded object is obtained, the executing unit 1001 sends an acquisition notification to the list monitoring unit 1002. Upon receiving the acquisition notification, the list monitoring unit 1002 monitors the number of entries in the additional acquisition list 1010 and notifies the start-up control unit 105 at a time when a predetermined condition is satisfied.

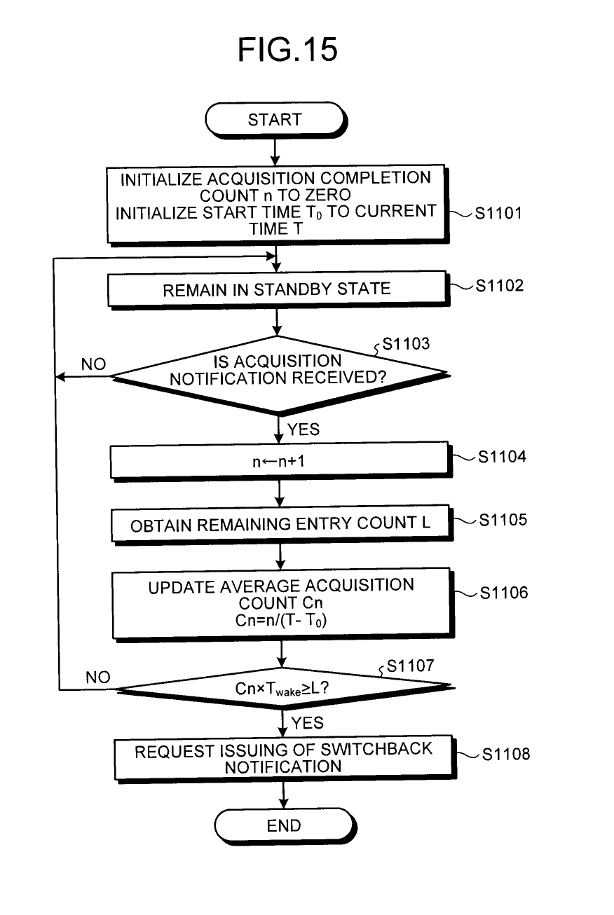

Given below is the detailed explanation of the operations performed by the list monitoring unit 1002. FIG. 15 is a flowchart for explaining the operations performed by the list monitoring unit 1002. The operations of the list monitoring unit 1002 are started in response to the notification from the transfer unit 404 of a URL which triggers in-advance batch acquisition. Moreover, it is assumed that a time T_{wake} that is required for the state transition of the first processor 110 is known.

Firstly, the list monitoring unit 1002 initializes an acquisition completion count n to zero and initializes a start time T₀ to a current time T (Step S1101). Then, the list monitoring unit 1002 waits until an acquisition notification is received from the executing unit 1001 (Step S1102, No at Step S1103).

Upon receiving an acquisition notification (Yes at Step S1103), the list monitoring unit 1002 increments the acquisition completion count n by one (Step S1104). Moreover, the list monitoring unit 1002 obtains a remaining entry count L (Step S1105). Furthermore, the list monitoring unit 1002 updates an average acquisition count Cn per unit time (Cn=(execution time of in-advance batch acquisition)/(acquisition count)=(T−T₀) /n) (Step S1106).

Subsequently, the list monitoring unit 1002 obtains an entry count Cn×T_{wake} of the entries that are likely to be completed within the time period required for state transition, and determines whether that entry count is equal to or greater than the remaining entry count L (Step S1107). If it is determined that the entry count is equal to or greater than the remaining entry count L (Yes at Step S1107), then the list monitoring unit 1002 requests the start-up control unit 105 to issue a switchback notification (Step S1108). On the other hand, if it is determined that the entry count is smaller than the remaining entry count L (No at Step S1107), then the list monitoring unit 1002 again waits until an acquisition request is received (i.e., the system control returns to Step S1102).

Herein, although the entry count Cn×T_{wake} of the entries that are likely to be completed within the time required for state transition is compared with the remaining entry count L; the entry count Cn×T_{wake} can have flexibility by taking into account the processing delay. For example, the entry count Cn×T_{wake} can be compared with the value obtained by adding one to the remaining entry count L.

Thus, in the communication device 500 according to the fifth embodiment described above, the timing of sending a switchback notification is changed so as to make it possible to enhance the responsiveness while maintaining the power saving condition.

According to each embodiment described above, an example is explained in which URLs are selected as first information, and embedded-objects that are associated to the webpages identified by the URLs are selected as second information. However, alternatively, it is also possible to select different information. For example, assume that a mailer is used as an application; email addresses are used as first information; only a header containing data volume is obtained in advance from an email server using email addresses; and the first processor is switched to the sleep state at the timing of obtaining the header. Then, while the actual data of emails is being obtained as second information, the first processor can be kept in the sleep state, and can be switched back to the operating state after all of the actual data is obtained. Herein, in order to obtain only the header, it is possible to use, for example, the POP3 STAT command.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a first processor configured to be switchable to a sleep state having low power consumption; and
a second processor configured to perform operations related to information acquisition via a network, wherein
the second processor includes:
a networking unit configured to, based on first information which indicates a connection destination of the network specified by the first processor, perform communication with the connection destination and notify a permission of switching the first processor to the sleep state;
an information obtaining unit configured to obtain second information which is associated to the first information; and
a start-up control unit configured to switch the first processor back to an operating state from the sleep state when the information obtaining unit finishes obtaining the second information associated to the first information specified by the first processor.

2. The device according to claim 1, wherein
the second processor further includes a time calculator configured to, based on the first information, calculate an acquisition time required for the information obtaining unit to obtain the second information, and
based on the acquisition time, the start-up control unit sets a sleep time for which the first processor remains in the sleep state, and notifies the first processor of the sleep time along with the permission of switching the first processor to the sleep state.

3. The device according to claim 2, wherein
the first processor includes a transfer unit configured to transfer the first information, which is notified from an application that performs communication through the network, to the second processor, and
the networking unit performs communication with the connection destination based on the first information thus transferred, and notifies a permission of switching the first processor to the sleep state upon receiving the first information.

4. The device according to claim 3, wherein the first processor further includes a sleep control unit configured to, upon receiving the permission of switching the first processor to the sleep state, switch the first processor to the sleep state and to, after the elapse of the sleep time since transition to the sleep state, start the first processor.

5. The device according to claim 4, wherein the sleep control unit calculates a second sleep time by subtracting a value, which is equal to or greater than a transition time required for the first processor to switch to the operating state from the sleep state, from the sleep time that is notified, and, after the elapse of the second sleep time, switches the first processor to a different sleep state from which switchback to the operating state is shorter as compared to the sleep state.

6. The device according to claim 4, wherein
the start-up control unit calculates a second sleep time by subtracting a value, which is equal to or greater than a transition time required for the first processor to switch to the operating state from the sleep state, and notifies the first processor of the sleep time and the second sleep time, and
after the elapse of the second sleep time since transition to the sleep state, the sleep control unit switches the first processor to a different sleep state from which switchback to the operating state is shorter as compared to the sleep state.

7. The device according to claim 5, further comprising a power source unit configured to supply power to the communication device, wherein
the sleep control unit calculates the second sleep time such that greater the power generation amount of the power source unit or greater the power storage amount remaining in the power source unit, shorter is the second sleep time.

8. The device according to claim 6, further comprising a power source unit configured to supply power to the communication device, wherein
the start-up control unit calculates the second sleep time such that greater the power generation amount the power source unit or greater the power storage amount remaining in the power source unit.

9. The device according to claim 1, wherein, when the time estimated to be required for obtaining remaining information, which is information not yet completely obtained from among the pieces of second information associated to the first information, becomes shorter than transition time required for the first processor to switch to the operating state from the sleep state, the start-up control unit switches the first processor back to the operating state from the sleep state.

10. A communication method implemented in a communication device that includes a first processor, which is switchable to a sleep state having low power consumption, and a second processor, which performs operations related to information acquisition via a network, the method comprising:
transferring, by the first processor, first information, which indicates a connection destination from which information notified by an application is to be obtained, to the second processor;
networking, by the second processor, that includes:
performing communication with the connection destination based on the first information, which indicates the connection destination of the network specified by the first processor; and
notifying a permission of switching the first processor to the sleep state;
obtaining, by the second processor, second information which is associated to the first information; and
switching, by the second processor, the first processor back to an operating state from the sleep state when the second information associated to the first information specified by the first processor are obtained.
